(19) United States
(12) Patent Application Publication
(10) Pub. No.: US 2019/0172043 A1
(43) Pub. Date: Jun. 6, 2019

(54) METHODS AND SYSTEMS FOR IMMEDIATE FARE NOTIFICATION IN ACCOUNT-BASED TICKETING

(71) Applicant: MasterCard International Incorporated, Purchase, NY (US)

(72) Inventors: Syam Sasidharan Nair, Singapore (SG); Shubhrendu Chandrashekhar Khoche, Singapore (SG); Chee Leong Liew, Singapore (SG)

(21) Appl. No.: 15/830,597

(22) Filed: Dec. 4, 2017

(51) Int. Cl. G06Q 20/32

(52) U.S. Cl. CPC G06Q 20/322; G06Q 20/3278

(57) ABSTRACT

A method includes, in response to a user presenting a payment-enabled mobile device at a first terminal device, receiving a first parameter at the mobile device indicating a first location associated with the first terminal device and storing the first parameter. In response to the user presenting the mobile device at a second terminal device, a second parameter is received at the mobile device indicating a second location associated with the second terminal device. Parameters, including the first parameter and the second parameter, are provided to a comparison mechanism on the mobile device configured to compare the parameters to fare calculation information stored in the mobile device. Based on the comparison, an amount to be deducted from an open-loop payment account stored in the mobile device is determined. A notification is generated on the mobile device indicating the amount to be deducted, for travel between the first location and the second location.

### BACKGROUND

With the advent of advancing mobile technology, “open-loop” or account-based ticketing and payments systems incorporating contactless technology have become commonplace in many cities. Unlike “closed-loop” or stored-value card based schemes, which often rely on propriety payments structures that lack interoperability across cities, open-loop ticketing systems allow travelers to pay for travel using their existing credit, debit, or pre-paid card, mobile device, or any other enabled payment media, and are globally interoperable. Open payment card acceptance removes barriers for travelers to pay without having to take the initial steps of buying a specific transit fare card and loading value onto it and eliminates the need to carry a separate card.

This automated fare collection solution has enabled transit authorities to move fare collection systems from field devices to a central back office system, allowing transit authorities to make changes to fare product offerings quickly and efficiently, relative to systems where each field device would otherwise need to be updated individually. The pricing, computing and managing of fares are handled at the back end. Fares are calculated in the back office after each trip has taken place.

One issue faced by digital wallet service providers is gaining the trust of travelers that the automated fare collection system will deduct the correct fare from their account every time they use it. Because the cost of each ride throughout a billing cycle is typically aggregated into a single transaction, the traveler has no way of knowing how much money was deducted from the digital wallet as the fare for each trip (e.g., users are only notified as to whether payment was successful). Currently, a traveler has to entrust the transport operators to charge them the correct fare later, at the back end.

What is needed is system and method capable of providing immediate fare notification when using a mobile wallet in account-based ticketing, for example, showing how much fare was deducted when a traveler finishes the journey. In this way, user experience may be optimized.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1 is a block diagram that illustrates a conventional payment system.

FIG. 2 is a diagram that schematically illustrates a mass transit system entrance and exit transaction in connection with which aspects of the present disclosure may be applied.

FIG. 3 is a flow chart that illustrates a process that may be performed according to aspects of the present disclosure in the system of FIG. 2.

FIG. 4 is an example screen display that may be presented to a user in connection with the process of FIG. 3.

FIG. 5 is a simplified block diagram illustration of a mobile device that may be used in the system of FIG. 2.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

In general, and for the purpose of introducing concepts of embodiments of the present disclosure, a payment-enabled mobile device may be used to enter a number of different transit systems which use compatible, “open-loop” payment systems.

A central database stores downloadable digital material (e.g., protocols) that may be used to control a short-range signaling (e.g., NFC—near field communication) capability of the mobile device so that it is able to engage in entry transactions with the transit entry terminals/payment systems of the various transit systems. A protocol may include one or more scripts, processing routines, data, parameters, flags and/or other resources that may be necessary to allow an application program to control the NFC functionality of the mobile device to emulate the functionality of a dedicated contactless IC transit access card for a particular transit system.

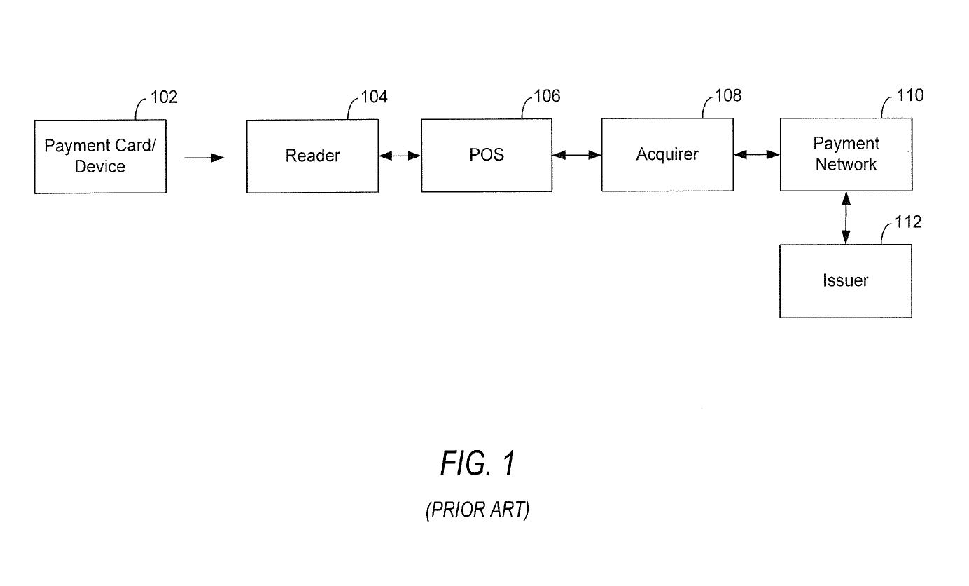

Initially, by way of background, aspects of a conventional payment account system will now be described with reference to FIG. 1.

FIG. 1 is a block diagram that illustrates a conventional payment system 100.

The system 100 includes a conventional payment card/device 102. Item 102 may be, for example, a magnetic stripe or IC (integrated circuit) payment card, a fob, or a payment-enabled mobile device that stores credentials for one or more payment accounts, etc. The system 100 further includes a reader component 104 associated with a POS terminal 106. In some known manner (depending on the type of the payment device 102) the reader component 104 is capable of reading the payment account number and other information from the payment device 102.

The reader component 104 and the POS terminal 106 may be located at the premises of a retail store/merchant and operated by a sales associate of the merchant for the purpose of processing retail transactions.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment account that is associated with the payment card/device 102. As is also well known, the authorization response generated by the payment account issuer server computer 112 may be routed back to the POS terminal 106 via the payment network 110 and the acquirer computer 108.

One well known example of a payment network is referred to as the “Banknet” system, and is operated by Mastercard International Incorporated, which is the assignee hereof.

The payment account issuer server computer 112 may be operated by or on behalf of a financial institution (“FI”) that issues payment accounts to individual users. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated proximity reader components. The system may also include a very large number of payment account holders, who carry payment devices for initiating payment transactions by presenting a payment account number to the reader component of a POS terminal.

For use-cases in which the payment card/device is embodied as a payment-enabled smartphone, the concept of a “digital wallet” has been introduced. In some implementations, the digital wallet (e.g., mobile wallet) takes the form of a payment-related application program (“app”) that is downloaded to and active on the smartphone. The user is permitted to load data (and/or an account-related payment app) corresponding to a number of different payment accounts (and possibly other types of credentials as well) into the wallet app. At the point of sale, the user opens the wallet app and selects one of the associated payment accounts for use in the present transaction. Via the wallet app or (as the case may be) the selected payment app, the corresponding payment credentials may be provided to the POS terminal to initiate the payment interaction among the merchant and other components of the payment account system.

The present inventors have now recognized that there are opportunities to improve user experience in the payment transaction process, particularly in situations where a payment-enabled mobile device is employed for the transaction, and a wallet app is running on the payment-enabled mobile device.

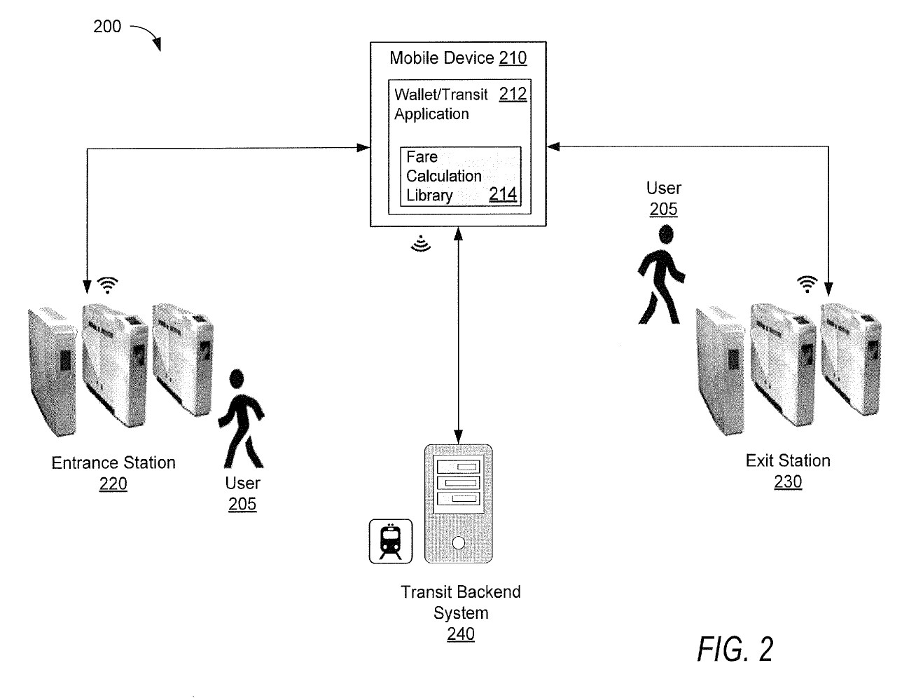

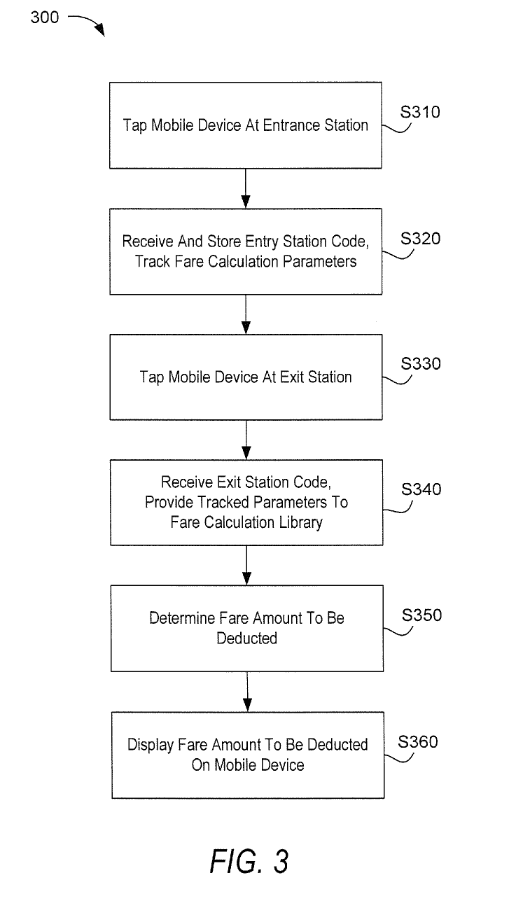

Reference is now made to FIGS. 2 and 3, which will be discussed together. FIG. 2 is a schematic illustration of an example embodiment. More specifically, FIG. 2 is a diagram that schematically illustrates a mass transit system entrance and exit transaction of transit system 200 in connection with which aspects of the present disclosure may be applied. In FIG. 2, the transit system 200 operates in accordance with the transaction processes of an open-loop payment system, which can perform transactions with general purpose payment account devices.

FIG. 3 is a flow chart that illustrates a process 300 that may be performed according to aspects of the present disclosure in the system of FIG. 2.

FIG. 2 shows a user 205 (also referred to as “rider” or “traveler”) operating a payment-enabled mobile device 210 (e.g., a suitably programmed smartphone) which performs payment functions in connection with transit system 200. It is assumed that the payment-enabled mobile device 210 was previously provisioned with a wallet/transit app 212 (e.g., Masterpass™, Apple Pay®, Android Pay™, or the like) and that one or more payment card accounts have been provisioned to the wallet app. The provisioning of the payment card accounts may have been accomplished via interaction between the mobile device 210 and a provisioning server (not shown). The provisioning server may act on behalf of one or more payment account issuers and may have performed a suitable ID&V (identification and verification) process before provisioning each payment app to the mobile device 210. The services of a provisioning server are commercially available, for example, via Mastercard Digital Enablement Service (MDES). The wallet app may previously have been downloaded to the mobile device from a merchant website (not shown).

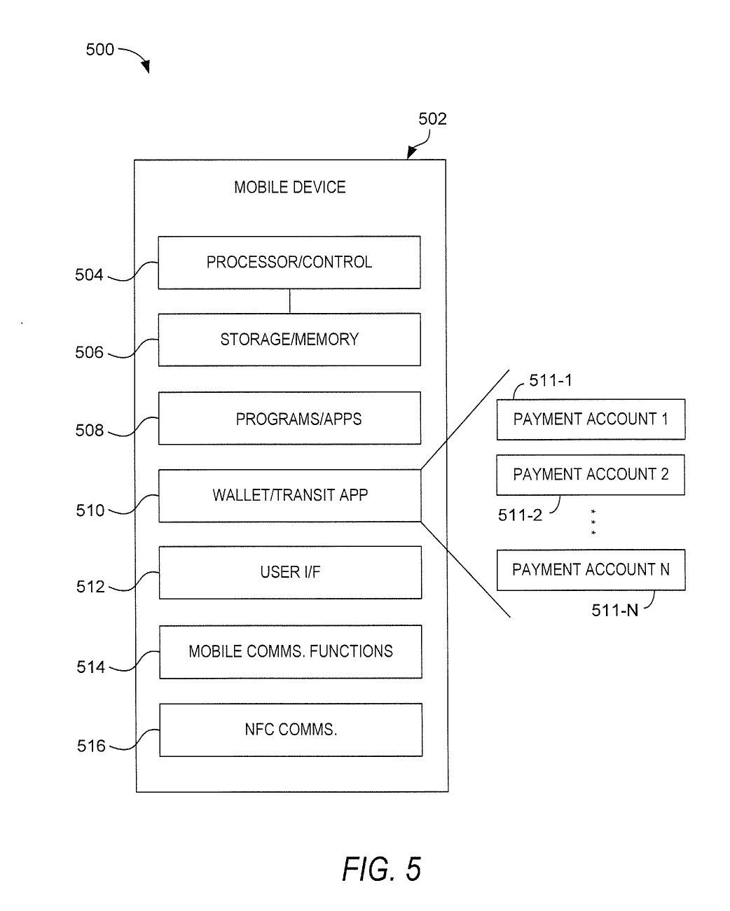

Further details of the mobile device 210 will be provided in later portions of this document, including the below discussion of FIG. 5.

A journey begins at S310 when user 205 touches or taps their payment-enabled mobile device 210 at an entrance station/gate 220 (or an associated reader) at which the user enters the transit system 200. The entrance station 220 is identified by a unique station code. In turn, at S320, a wallet/transit app 212 implemented in the mobile device 210 receives an entry station code from the entrance station 220 and stores this station code.

In addition to the entry station code, wallet/transit app 212 may, at S320, track additional parameters to determine the fee for the fare in some transportation systems (e.g., until the user arrives at a destination point). In some embodiments, the per-ride charge may depend on, for example, the time of travel (e.g., peak, off-peak), the overall time spent in transit, the distance traveled, zones traversed, the mode of transportation (e.g., train, subway, bus, taxi, ferry), user category (e.g., student, child, senior), fare class (e.g., first class, economy class), and/or the like.

In some systems, the initial entry transaction merely indicates the starting point of the trip, and the user/rider is again required to engage in a transaction with a transit system terminal upon exiting from the transit system 200 at the end of the ride. The journey ends at S330 when user 205 touches or taps their payment-enabled mobile device 210 an exit station/gate 230 (or an associated reader) at which the user departs the transit system 200. The exit station 230 is identified by a unique station code. In turn, at S340, the wallet/transit app 212 implemented in the mobile device 210 receives an exit station code from the exit station 230 and provides the parameters tracked in steps S310 to S350, including the entry station code and the exit station code, to fare calculation library 214. The fare calculation library 214 may be provided with the mobile wallet as pre-integrated with the mobile wallet app 212 or as an optional functionality.

Exchange of short-range radio communications between the payment-enabled mobile device 210 and the transit system terminals 220, 230 are also schematically illustrated in FIG. 2.

In some embodiments, such as for a transit bus system, entrance station 220 and exit station 230 may be the same device (e.g., bus fare box).

Next, at S350, wallet/transit app 212 performs a fare lookup (e.g., using a fare calculation table including a value for each particular fare charge corresponding to travel from a point of origin to a point of destination) and determines the fare amount to be deducted from an open-loop payment account stored in the mobile device 210, for transit between a first location associated with entrance station 220 and a second location associated with exit station 230.

The corresponding amount is deducted from the open-loop payment account at the backend by transit backend system 240. Users are charged for the fare at a later time. This is because in account-based ticketing, a user's account is created at the backend of transit systems and enter-exit taps of a user's payment card (e.g., mobile wallet) are tracked against this account. Fare collection occurs at a later time, either as a batch or aggregate payment processed based on an agency's threshold or as a delayed payment process.

Typically, transactions of entry taps at 220 and exit taps at 230 are aggregated at transit backend system 240 and applicable fare logic is applied before payment is collected through the merchant acquiring banks (e.g., to minimize interchange fees). That is, individual fare payments associated with the same user may be aggregated into a single financial transaction.

As a result, the user's billing statement typically appears as a single transaction representing the cost of ride(s) taken throughout an entire billing cycle aggregated into the single transaction. For example, in some cases, the per-ride charges are aggregated into a single transaction for settlement when the accumulated charge reaches a certain amount, while in other cases, the per-ride charges are periodically aggregated into a single transaction for settlement.

Advantageously, here at S360, by way of fare calculation library 214, wallet/transit app 212 may display the possible fare deduction amount for the user's journey on the user's mobile device 210 (e.g., user interface) in real-time.

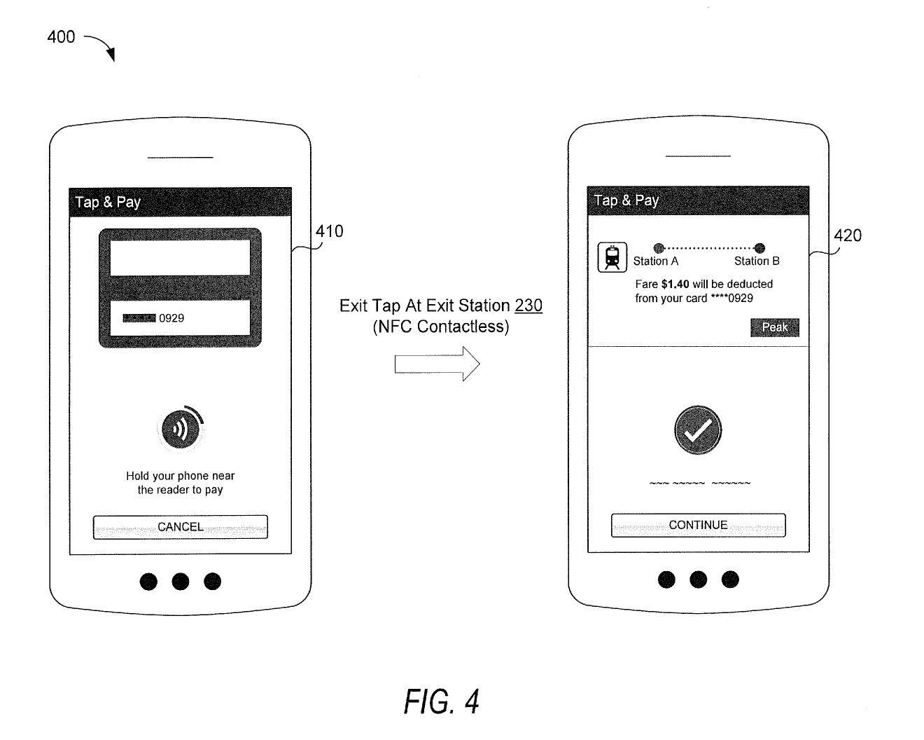

For example, upon an exit tap at the exit station 230 (e.g., NFC contactless transaction), the user may see a message displaying the per-ride charge that will be deducted from their open payment card as shown in FIG. 4.

In some embodiments, fare calculation information 214 may, from time to time, be updated. A synchronization process between the mobile device 210 and the transit backend system 240 may be performed to acquire the latest fare calculation information 214 from the transit backend system 240 (e.g., central back office system of a transit authority). For example, the fare calculation information 214 may be updated to reflect current service advisories (e.g., signal malfunctions, planned track work, weather-related or emergency disruptions of service, or other transit system interruptions), changes to fare product offerings, changes to fare calculation logic/data, and the like.

In an example use-case, due to a signal fault resulting in no train service from one station to another station, a transit authority may determine the routes that are affected and decide to offer alternative travel/route options at no additional charge (e.g., free boarding of buses at bus stops). Such updated fare details are synced to the mobile device 210 where they are available to accurately determine the fare charge corresponding to travel from a point of origin to a point of destination.

FIG. 4 is an example screen display that may be presented to a user in connection with the process of FIG. 3. More specifically, FIG. 4 illustrates one example user experience including a user interface (UI) that is provided for immediate fare notification when using a digital wallet (e.g., MasterPass™) in account-based ticketing.

By way of example, user 205, shown user interface 410, holds their phone near the reader at exit station 230 to pay. Upon an exit tap at exit station 230, user 205 is shown user interface 420, with an indication that payment was successful (e.g., acknowledged/confirmed). Additionally or alternatively, the user is shown a notification message indicating an amount that will deducted from their open payment card (e.g., “Fare $1.40 will be deducted from your card ****0929”), for travel between a point of origin to a point of destination (e.g., between “Station A” and “Station B”). Other parameters used to determine the per-ride charge (e.g., travel during “Peak” travel time) may also be displayed on user interface 420.

Additionally or alternatively in this or other embodiments, user 205 may view transit journey histories, including current, upcoming and/or past travel details, within wallet/transit app 212 (e.g., via a mobile wallet user interface).

Additionally or alternatively in this or other embodiments, user 205 may be provided with real-time travel updates, along with the option activate third-party offers/coupons (e.g., location-based offers/coupons), and any other suitable information related to travelers.

For example, in some embodiments, the wallet/transit app 212 may provide functionality to support delivery of location-based offers to the mobile device 210. Mobile device 210 may be used to facilitate communication with, for example other devices such as an offer resources server computer (not shown). An offer resources server computer may store data indicative of potential location-based offers that may be delivered to an audience of travelers according to aspects of the present disclosure. For example, real-time offers may be pushed to wallet/transit app 212 based on the exit station identification at S340.

A real-time offer system as described above may be a highly efficient mode of delivering marketing messages, by leveraging the existing infrastructure transit payment systems and their corresponding terminal devices installed in large numbers of transit systems. Furthermore, the offers presented to travelers according to this system are likely to be of interest to, and accepted by, the travelers at a rather high rate, because the offers have been selected based on the travelers' location, etc.

Although FIG. 2 depicts an environment for permitting the user to access a rail-based underground and/or elevated mass transit system, at least some aspects of the present disclosure may also be applicable to transit system terminals operated on buses, trolleys, trams, etc. to secure or confirm payment for access to vehicles of those kinds.

FIG. 5 is a simplified block diagram of an example embodiment of a mobile device 210 as shown in FIG. 2.

The mobile device 210 may include a housing 502. In many embodiments, the front of the housing 502 is predominantly constituted by a touchscreen (not separately shown), which is a key element of the user interface 512 of the mobile device 210.

The mobile device 210 further includes a mobile processor/control circuit 504, which is contained within the housing 502. Also included in the mobile device 210 is a storage/memory device or devices (reference numeral 506). The storage/memory devices 506 are in communication with the processor/control circuit 504 and may contain program instructions to control the processor/control circuit 504 to manage and perform various functions of the mobile device 210. As is well-known, a device such as mobile device 210 may function as what is in effect a pocket-sized personal computer (assuming for example that the mobile device is a smartphone), via programming with a number of application programs, or “apps,” as well as a mobile operating system (OS). (The apps are represented at block 508 in FIG. 5, and may, along with other programs, in practice be stored in block 506, to program the processor/control circuit 504.)

Also shown in FIG. 5 is a wallet/transit app 510. The wallet/transit app 510 is shown apart from the other apps represented at block 508, in part due to the particular relevance of the wallet/transit 510 to the subject of this disclosure. In some respects the wallet app may operate with typical functionality of wallet apps that have been previously proposed or deployed, in that through interaction with the wallet/transit app 510, the user may be permitted to select among and access a number of payment accounts (also referred to as payment apps) (reference numerals 511-1, 511-2, . . . , 511-N) that have been provisioned to the mobile device 210 and associated with the wallet/transit app 510.

In some embodiments, the wallet app and/or payment account data may be stored in a secure element or “SE” (not shown apart from block 506 or block 510, 511), which may be provided in some embodiments of the payment-enabled mobile device 210 to provide enhanced security for the payment apps 511 and/or sensitive data associated therewith. The SE, if present, may be conventional in its hardware aspects. In addition or alternatively, security for the payment apps 511 may be enhanced by known alternatives to an SE, such as a TEE (trusted execution environment).

To the extent that the SE includes processing capabilities, it may functionally (though likely not physically) overlap with block 504; to the extent that the SE includes storage (and particularly program storage) capabilities, it may functionally (though likely not physically) overlap with block 506.

In some embodiments, the wallet/transit app 510 may resemble a typical wallet app as previously proposed for or implemented in payment-enabled mobile devices. However, the wallet/transit app 510 may also, in accordance with teachings of this disclosure, have further capabilities and provide additional functionality as described herein. To briefly describe those capabilities, the wallet/transit app 510 may utilize/be guided by a fare calculation library 214 associated therewith in order to engage in immediate fare calculations.

Although several payment accounts 511 are illustrated in FIG. 5, it may alternatively be the case that only one or two payment accounts 511 are associated with the merchant wallet/transit app 510.

As is typical for mobile devices, the mobile device 210 may include mobile communications functions as represented by block 514. The mobile communications functions may include voice and data communications via a mobile communication network (not shown) with which the mobile device 210 is registered.

In addition, to facilitate use as a device for providing transit access to its user (and possibly also to facilitate use for contactless payment transactions in general), the mobile device 210 may include short-range radio communications capabilities (block 516), including for example NFC (near field communication). Thus block 516 may represent a suitable antenna (not separately shown) that is appropriate for NFC communications as well as driving and receiving circuitry associated with the antenna. It will be appreciated that the NFC antenna may be separate and different from the antenna (not separately shown) utilized by the mobile device 210 for the mobile communication functions represented by block 514.

In some embodiments, a biometric sensor (not shown), may be one of the components of the payment-enabled mobile device 210. The biometric sensor may be, for example, a fingerprint sensor, and may operate to assist in verifying the user of the device in connection with payment transactions.

From the foregoing discussion, it will be appreciated that the blocks depicted in FIG. 5 as components of the mobile device 210 may in effect overlap with each other, and/or there may be functional connections among the blocks which are not explicitly shown in the drawing. It may also be assumed that, like a typical smartphone, the mobile device 210 may include a rechargeable battery (not shown) that is contained within the housing 210 and that provides electrical power to the active components of the mobile device 210.

It has been posited that the mobile device 210 may be embodied as a smartphone, but this assumption is not intended to be limiting, as mobile device 210 may alternatively, in at least some cases, be constituted by a tablet computer, a smartwatch or by other types of portable electronic devices.

In other alternative embodiments, instead of or in addition to a conventional transit terminal, the point of access to a transit system may feature a fixedly installed smartphone or the like. The latter device may have biometric reading capabilities such as a thumb/fingerprint scanner or a retinal scanner, and may allow users to identifying themselves biometrically to obtain entrance to the transit system. In response to detecting the individual's biometric characteristic, the transit system may use a “card on file” or prepaid balance arrangement to support obtaining payment for the user's access to the transit system.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The above descriptions and illustrations of processes herein should not be considered to imply a fixed order for performing the process steps. Rather, the process steps may be performed in any order that is practicable, including simultaneous performance of at least some steps.

Although the present disclosure has been set forth in relation to specific example embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a first parameter at a payment-enabled mobile device indicating a first location associated with a first terminal device, in response to a user presenting the mobile device at the first terminal device;
storing the first parameter;
receiving a second parameter at the mobile device indicating a second location associated with a second terminal device, in response to the user presenting the mobile device at the second terminal device;
providing parameters, including the first parameter and the second parameter, to a comparison mechanism on the mobile device configured to compare the parameters to fare calculation information stored in the mobile device;
determining an amount to be deducted from an open-loop payment account stored in the mobile device based on the comparison; and
generating a notification on the mobile device indicating the amount to be deducted, for travel between the first location and the second location.

2. The method of claim 1, wherein the parameters further comprise one or more of: a time of travel, a duration of travel, a distance of travel, a mode of transportation, a user category, and a fare class.

3. The method of claim 1, wherein the first terminal device is an entrance station of a transit system and the second terminal device is an exit station of the transit system.

4. The method of claim 3, wherein the first parameter includes entrance station identification information and the second first parameter includes exit station identification information.

5. The method of claim 1, further comprising providing the comparison mechanism with updated fare calculation information.

6. The method of claim 1, wherein the first terminal device and the second terminal device are the same device.

7. The method of claim 1, further comprising receiving one or more push messages on the mobile device based on the first location or the second location.

8. The method of claim 7, wherein the push messages include promotional offer information.

9. The method of claim 1, wherein the mobile device communicates with the first terminal device and the second terminal device via NFC (near field communication).

10. A system comprising:
a processor; and
a memory in communication with the processor, the memory storing program instructions, the processor operative with the program instructions to perform functions as follows:
receive a first parameter at a payment-enabled mobile device indicating a first location associated with a first terminal device, in response to a user presenting the mobile device at the first terminal device;
store the first parameter;
receive a second parameter at the mobile device indicating a second location associated with a second terminal device, in response to the user presenting the mobile device at the second terminal device;
provide parameters, including the first parameter and the second parameter, to a comparison mechanism on the mobile device configured to compare the parameters to fare calculation information stored in the mobile device;
determine an amount to be deducted from an open-loop payment account stored in the mobile device based on the comparison; and
generate a notification on the mobile device indicating the amount to be deducted, for travel between the first location and the second location.

11. The system of claim 10, wherein the parameters further comprise one or more of: a time of travel, a duration of travel, a distance of travel, a mode of transportation, a user category, and a fare class.

12. The system of claim 10, wherein the first terminal device is an entrance station of a transit system and the second terminal device is an exit station of the transit system.

13. The system of claim 12, wherein the first parameter includes entrance station identification information and the second first parameter includes exit station identification information.

14. The system of claim 10, further comprising the mobile device in communication with a central computer, providing the comparison mechanism with updated fare calculation information.

15. The system of claim 10, wherein the first terminal device and the second terminal device are the same device.

16. The system of claim 10, further comprising receiving one or more push messages on the mobile device based on the first location or the second location.

17. The system of claim 16, wherein the push messages include promotional offer information.

18. The system of claim 10, wherein the mobile device communicates with the first terminal device and the second terminal device via NFC (near field communication).

19. A non-transitory computer readable medium having stored therein instructions that when executed cause a computer to perform a method comprising:
receiving a first parameter at a payment-enabled mobile device indicating a first location associated with a first terminal device, in response to a user presenting the mobile device at the first terminal device;
storing the first parameter;
receiving a second parameter at the mobile device indicating a second location associated with a second terminal device, in response to the user presenting the mobile device at the second terminal device;
providing parameters, including the first parameter and the second parameter, to a comparison mechanism on the mobile device configured to compare the parameters to fare calculation information stored in the mobile device;
determining an amount to be deducted from an open-loop payment account stored in the mobile device based on the comparison; and
generating a notification on the mobile device indicating the amount to be deducted, for travel between the first location and the second location.

20. The non-transitory computer readable medium of claim 19, the method further comprising providing the comparison mechanism with updated fare calculation information.
